(19) United States
(12) Patent Application Publication
(10) Pub. No.: US 2017/0342989 A1
(43) Pub. Date: Nov. 30, 2017

(54) Power Supply Using an Electric Fan to Generate Wind Power

(71) Applicants: Chun-Ying Cheng, Taoyuan City (TW); Jie-Hong Cheng, Taoyuan City (TW)

(72) Inventors: Chun-Ying Cheng, Taoyuan City (TW); Jie-Hong Cheng, Taoyuan City (TW)

(21) Appl. No.: 15/166,324

(22) Filed: May 27, 2016

(51) Int. Cl. F04D 25/04; F04D 19/00; F04D 29/52; F03D 5/00; F04D 25/16; F04D 25/06; F04D 29/32; F04D 29/38; H02K 53/00

(52) U.S. Cl. CPC F04D 25/04; F04D 29/325; F04D 19/002; F04D 29/522; F04D 29/38; F03D 5/00; F04D 25/166; F04D 25/0673; H02K 53/00; Y10S 74/09

(57) ABSTRACT

A power supply includes a housing receiving an electric motor, first and second fans, a generator, and a power device. The generator is concentrically mounted around the electric motor. When the electric motor is supplied with electricity from the power device and operates, a shaft of the electric motor drives the first fan to rotate, generating wind power close to the second fan. The second fan is rotated by the wind power in the housing and drives the second rotor and the second rotor seat to rotate. The first and second magnets create repulsive and attractive forces to provide inertia driving the second rotor seat, making the generator continuously supply electricity to the power device and the electric motor, thereby keeping the electric motor running to generate the wind power while the first fan continuously using the wind power to drive the second fan and the generator to generate electricity.

### BACKGROUND OF THE INVENTION

The present invention relates to a power supply and, more particularly, to a power supply using an electric fan to generate wind power.

With continuous improvement in development and applications of technologies, illuminating equipment, 3C products, and small household electrical appliances (such as electric lamps, televisions, electric fans, mobile phones, tablet computers, personal digital assistants, etc.) have become necessary electrical and electronic products in daily lives.

These electrical and electronic products mainly depend on internal cells or external power sources to maintain normal operation. Mobile chargers (or mobile power banks) and combustion generators have been available on the market. Most of the mobile chargers use batteries as the power sources to permit users to continuously use the electrical and electronic products and charge the electrical and electronic products at any time and place.

However, these combustion generators and mobile chargers still require fueling or charging in advance and cannot provide the power by themselves. Furthermore, these combustion generators and mobile chargers continuously consume the fuel or electricity when carried and used outside, such that the users cannot find any other power supplies when the power is run out. Thus, it is an important issue to persons in this field.

### BRIEF SUMMARY OF THE INVENTION

A power supply according to the present invention includes a housing having a first end wall, a second end wall, and a peripheral wall interconnected between the first and second end walls, defining a compartment therebetween. The housing further includes at least one vent intercommunicated with the compartment. An electric motor includes a fixed seat fixed to the first end wall and located in the compartment. The electric motor further includes a shaft having an end extending perpendicularly to and rotatably mounted to the fixed seat. The electric motor further includes a first stator having an end fixed on the fixed seat and a first rotor fixed to the shaft. The first stator and the first rotor are concentrically mounted around the shaft. The other end of the shaft extends beyond the first stator. A first fan is fixed to the other end of the shaft. A generator is concentrically mounted around the electric motor. The generator includes a second stator and a second rotor concentrically disposed in relation to the second stator. The second stator has an end fixed to the fixed seat. A second rotor seat is fixed to the second rotor. The second rotor seat includes an end rotatably mounted to the other end of the shaft. A second fan is fixed to the end of the second rotor. The second fan faces the first fan. The first and second fans are coaxial, opposite to each other, and adjacent to each other. At least one first magnet is fixed in the compartment and is located outside of the generator. A plurality of second magnets is annularly fixed around the second rotor seat. The at least one magnet surrounds the plurality of second magnets. A power device is mounted to the housing. The power device is electrically connected to the generator and the electric motor. The power device is adapted to supply electricity to an outside.

When the electric motor is supplied with electricity from the power device and operates, the first rotor and the shaft of the electric motor drive the first fan to rotate, generating wind power close to the second fan. The second fan is driven to rotate by the wind power in the compartment of the housing. The second fan drives the second rotor and the second rotor seat of the generator to rotate. The magnetic lines of the at least one first magnet and the plurality of second magnets create repulsive and attractive forces to provide inertia driving the second rotor seat to rotate, making the generator continuously generate and supply electricity to the power device and the electric motor, thereby keeping the electric motor running, and wherein the power device is adapted to output electricity to an external electrical appliance.

In an example, the first rotor of the electric motor is located around and spaced from the first stator. A first stator seat extends upwards from an intermediate portion of the fixed seat and has an axial hole. The shaft rotatably extends through the axial hole. The first stator is fixed around the first stator seat. A first rotor seat is fixed around the first rotor. The first rotor seat includes an end fixed to the shaft. The second rotor seat is fixed around the second rotor.

In an example, a side of the first fan is located adjacent to the second end wall, and the second fan is located adjacent to the other side of the first fan.

In an example, the end of the second rotor seat of the generator includes a plurality of ventilation holes, and the second fan includes a plurality of blades formed on the end of the second rotor seat.

In an example, each of the plurality of second magnets includes two ends having opposite polarities. Two adjacent ends respectively of two adjacent second magnets have opposite polarities. The at least one first magnet extends along an axis parallel to and spaced from a tangent to one of the plurality of second magnets and has two ends with opposite polarities.

In another example, the plurality of second magnets is arranged in a circumferential direction and spaced from each other. Each of the plurality of second magnets includes inner and outer sides having opposite polarities. The polarities of the outer sides of the plurality of second magnets are identical. The at least one first magnet extends along an axis parallel to and spaced from a tangent to one of the plurality of second magnets and includes a first side facing one of the plurality of the second magnets. The first side of the at least one first magnet has a polarity identical to the polarity of the outer side of the one of the plurality of second magnets.

In an example, the first stator of the electric motor is located around and spaced from the first rotor. An axle extends upwards from an intermediate portion of the fixed seat. A first rotor seat is fixed to an inner periphery of the first rotor. The first rotor seat includes an end fixed to the shaft. The first rotor seat further includes an axial hole extending downwards and rotatably receiving the axle. A first stator seat extends upwards from the fixed seat. The first stator is fixed to an inner periphery of the first stator seat.

In an example, the second rotor of the generator can be located around and spaced from the second stator. The second stator is fixed around the first stator seat. The second rotor seat is fixed around the second rotor. The end of the second rotor seat includes a first side located adjacent to the second end wall and surrounding the first fan. The end of the second rotor seat includes a plurality of ventilation holes. The end of the second rotor seat further includes a second side having a plurality of blades forming the second fan.

In another example, the second stator of the generator is located around and spaced from the second rotor. A second stator seat extends upwards from the fixed seat. The second stator is fixed to an inner periphery of the second stator seat. The second rotor seat is fixed to an inner periphery of the second rotor. A cylindrical portion extends outwards from the end of the second rotor seat and surrounding the second stator seat. The plurality of second magnets is annularly fixed around the cylindrical portion of the second rotor seat. The first fan has a side adjacent to the second end wall, and the second fan is located adjacent to the other side of the first fan.

In an example, the power device includes a charging controller, a rechargeable battery, and a voltage boost circuit. The charging controller is electrically connected to the generator and the rechargeable battery. The rechargeable battery is electrically connected to the electric motor and the voltage boost circuit. The voltage boost circuit is adapted to be electrically connected to the external electrical appliance.

The present invention will become clearer in light of the following detailed description of illustrative embodiments of this invention described in connection with the drawings.

### DESCRIPTION OF THE DRAWINGS

FIG. 1 is a diagrammatic cross sectional view of a power supply of a first example according to the present invention.

FIG. 2 is a block diagram of the power supply of FIG. 1.

FIG. 3 is a diagrammatic top view illustrating an example of disposition of first magnets and second magnets of the power supply of FIG. 1.

FIG. 4 is a diagrammatic top view illustrating another example of disposition of the first magnets and the second magnets of the power supply of FIG. 1.

FIG. 5 is a diagrammatic cross sectional view of a power supply of a second example according to the present invention.

FIG. 6 is a diagrammatic cross sectional view of a power supply of a third example according to the present invention.

### DETAILED DESCRIPTION OF THE INVENTION

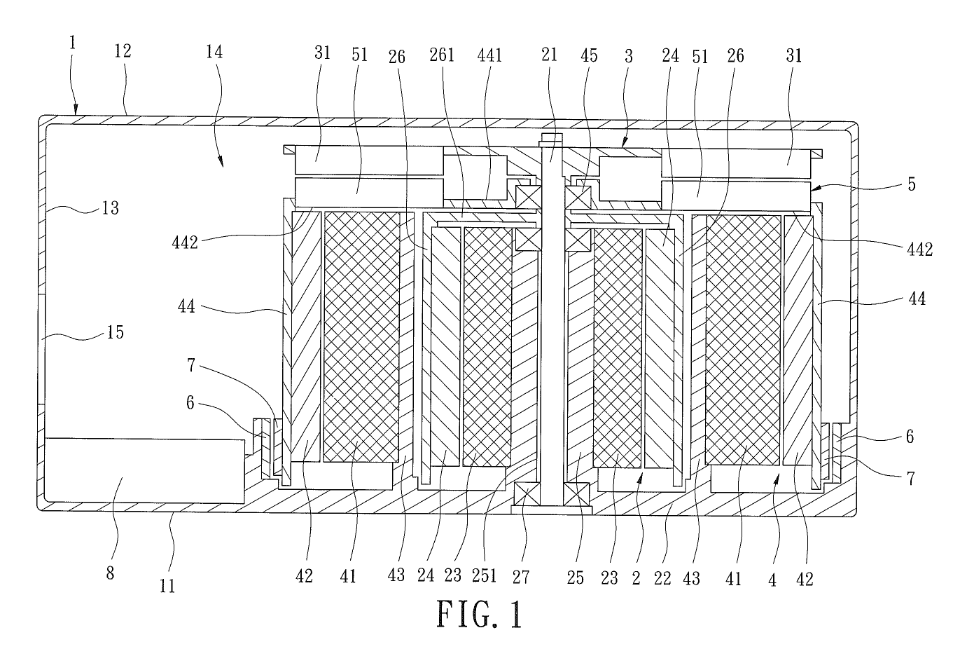

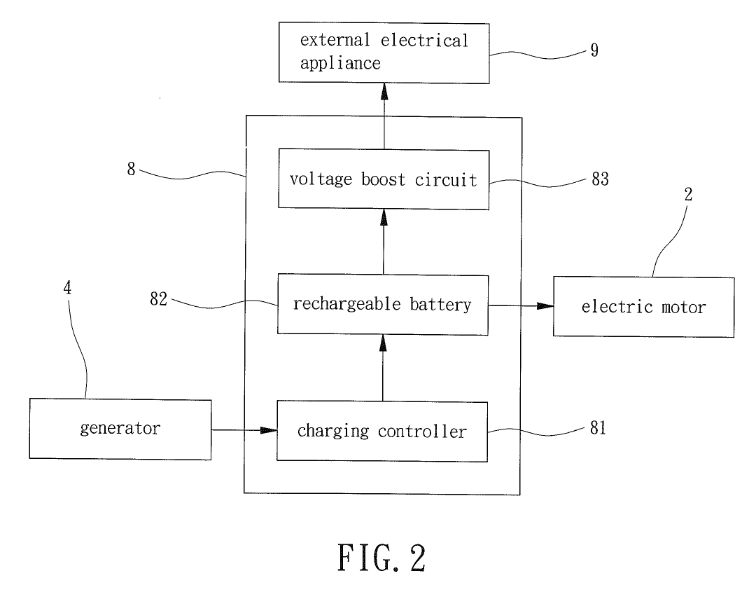

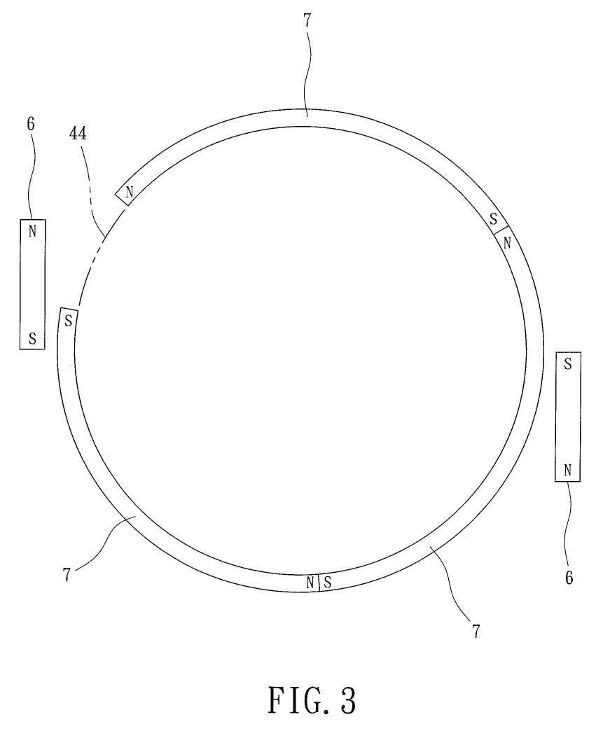

FIGS. 1-3 show a power supply using an electric fan to generate wind power of a first example according to the present invention. The power supply includes a housing 1, an electric motor 2, a first fan 3, a generator 4, a second fan 5, at least one first magnet 6, a plurality of second magnets 7, and a power device 8 and is adapted to continuously and stably provide electricity to an external electrical appliance 9.

The housing 1 includes a first end wall 11, a second end wall 12 opposite to the first end wall 11, and a peripheral wall 13 interconnected between the first and second end walls 11 and 12, defining a compartment 14 therebetween. The first end wall 11, the second end wall 12, or the peripheral wall 13 can be detached. In this example, the housing 1 includes at least one vent 15 defined in the peripheral wall 13, the first end wall 11, or the second end wall 12 and intercommunicated with the compartment 14.

The electric motor 2 includes a fixed seat 22 fixed to the first end wall 11 and located in the compartment 14. The electric motor 2 further includes a shaft 21 having an end extending perpendicularly to and rotatably mounted to the fixed seat 22. The electric motor 2 further includes a first stator 23 having an end fixed on the fixed seat 22 and a first rotor 24 fixed to the shaft 21. The first stator 23 and the first rotor 24 are concentrically mounted around the shaft 21. An end of the shaft 21 extends beyond the first stator 23. In this example, the first rotor 24 of the electric motor 2 is located around and spaced from the first stator 23. A first stator seat 25 extends upwards from an intermediate portion of the fixed seat 22 and has an axial hole 251. The shaft 21 rotatably extends through the axial hole 251 and a bearing 27. The first stator 23 is fixed around the first stator seat 25. A first rotor seat 26 is fixed around the first rotor 24. The first rotor seat 26 includes an end 261 fixed to the shaft 21.

The first fan 3 is fixed to the other end of the shaft 21 and includes a plurality of blades 31 spaced from each other. The first fan 3 is located adjacent to the second end wall 12 and faces the first end wall 11 for delivering wind power.

The generator 4 is concentrically mounted around the electric motor 2. The generator 4 includes a second stator 41 and a second rotor 42 concentrically disposed in relation to the second stator 41. An end of the second stator 41 is fixed to the fixed seat 22. In this example, the second rotor 42 of the generator 4 is located around and spaced from the second stator 41. A second stator seat 43 extends upwards from the fixed seat 22 and extends around and is spaced from the first rotor 24. The second stator 41 is fixed around the second stator seat 43. A second rotor seat 44 is fixed around the second rotor 42. The second rotor seat 44 includes an end 441 rotatably mounted to the other end of the shaft 21 by a bearing 45. The end 441 of the second rotor seat 44 includes a plurality of ventilation holes 442.

The second fan 5 is fixed to the end 441 of the second rotor seat 44. The second fan 5 includes a plurality of blades 51 spaced from each other and formed on the end 441 of the second rotor seat 44. The second fan 5 faces the second end wall 12 and the other side of the first fan 3. The first and second fans 3 and 5 are coaxial, opposite to each other, and adjacent to each other.

In this example, the power supply includes two first magnets 6. Each first magnet 6 is fixed in the compartment 14 and is located outside of the generator 4.

The second magnets 7 are annularly fixed around the second rotor seat 44. The magnets 6 surround the second magnets 7. Two ends of each second magnet 7 have opposite polarities. Two adjacent ends respectively of two adjacent second magnets 7 have opposite polarities. Two of the second magnets 7 are spaced from each other. Each first magnet 6 extends along an axis parallel to and spaced from a tangent to one of the second magnets 7 and has two ends with opposite polarities.

The power device 8 is mounted in the compartment 14 of the housing 1. The power device 8 is electrically connected to the generator 4 and the electric motor 2. The power device 8 is adapted to supply electricity to the external electrical appliance 9. In this example, the power device 8 includes a charging controller 81, a rechargeable battery 82, and a voltage boost circuit 83. The charging controller 81 is electrically connected to the generator 4 and the rechargeable battery 82. The rechargeable battery 82 is electrically connected to the electric motor 2 and the voltage boost circuit 83. The voltage boost circuit 83 is adapted to be electrically connected to the external electrical appliance 9.

When the electric motor 2 is supplied with electricity from the rechargeable battery 82 of the power device 8 and operates for the first time, the first rotor 24 and the shaft 21 of the electric motor 2 drive the first fan 3 to rotate, generating wind power close to the second fan 5. The second fan 5 is driven to rotate by the wind power in the compartment 14 of the housing 1. Furthermore, the second fan 5 drives the second rotor 42 and the second rotor seat 44 of the generator 4 to rotate. The magnetic lines of the first magnets 6 and the second magnets 7 create repulsive and attractive forces to provide inertia driving the second rotor seat 44 to rotate, making the generator 4 continuously generate and supply electricity to the power device 8 and the electric motor 2, thereby keeping the electric motor 2 running to generate the wind power while the first fan 3 continuously using the wind power to drive the second fan 5 and the generator 4 to generate electricity. Thus, the power device 8 can continuously and stably output electricity to the external electrical appliance 9. As a result, the power supply can rapidly generate electricity at any time and place to prolong the service time of the external electrical appliance 9, avoiding closing down of the external electrical appliance 9 due to running out of electricity. The concentric arrangement of the electric motor 2 and the generator 4 makes the power supply compact, which is easy to manufacture and which reduces the manufacturing costs. Furthermore, the first fan 3 is mounted on the shaft 21 of the electric motor 2 and is located adjacent to the second fan 5, such that the outer diameters of the first and second fans 3 and 5 can match with the outer diameter of the generator 4, reducing the volume of the housing 1 and using the wind to help dissipation of the generator 4 and the electric motor 2.

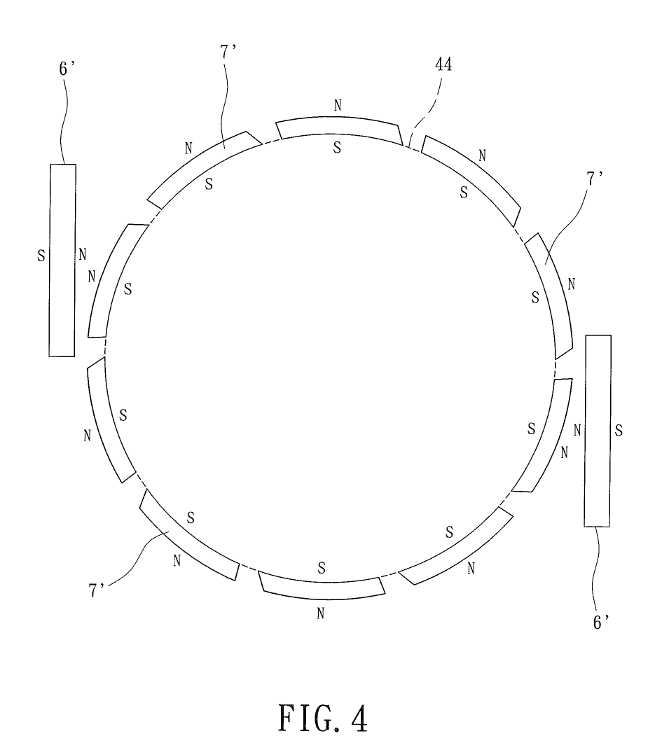

FIG. 4 shows another example of disposition of the first magnets 6′ and the second magnets 7′. The second magnets 7′ are arranged around the second rotor seat 44 in a circumferential direction and are spaced from each other. Each second magnet 7′ includes inner and outer sides having opposite polarities. The polarities of the outer sides of the second magnets 7′ are identical. Each first magnet 6′ extends along an axis parallel to and spaced from a tangent to one of the second magnet 7′ and includes a first side facing one of the second magnets 7′. The first side of each first magnet 6′ has a polarity identical to the polarity of the outer side of one of the second magnets 7′ adjacent to the first magnet 6′. When the second fan 5 drives the second rotor 42 and the second rotor seat 44 of the generator 4 to rotate, the magnetic lines of the first magnets 6′ and the second magnets 7′ create repulsive and attractive forces to provide inertia driving the second rotor seat 44 to rotate.

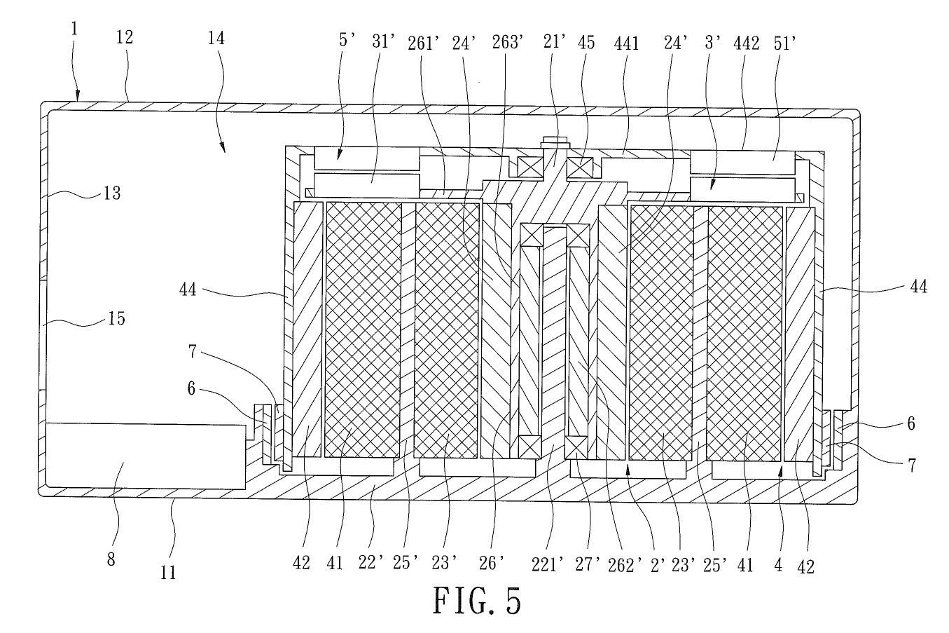

FIG. 5 shows a second example of the power supply. The second example is different from the first example by that the first stator 23′ of the electric motor 2′ is located around and spaced from the first rotor 24′. An axle 221′ extends upwards from an intermediate portion of the fixed seat 22′. A first rotor seat 26′ is fixed to an inner periphery of the first rotor 24′. The first rotor seat 26′ includes an end 261′ fixed to the shaft 21′. The first rotor seat 26′ further includes an axial hole 263′ extending downwards and receiving a sleeve 262′ and a bearing 27′, thereby rotatably receiving the axle 221′. A first stator seat 25′ extends upwards from the fixed seat 22′. The first stator 23′ is fixed to an inner periphery of the first stator seat 25′. In this example, the second rotor 42 of the generator 4 is located around and spaced from the second stator 41. The second stator 41 is directly fixed around the first stator seat 25′. A second rotor seat 44 is fixed around the second rotor 42. The second rotor seat 44 has an end 441 rotatably mounted to the other end of the shaft 21′. A first side of the end 441 of the second rotor seat 44 is located adjacent to the second end wall 12 and surrounds the first fan 3′. The end 441 of the second rotor seat 44 includes a plurality of ventilation holes 442. A second side of the end 441 of the second rotor seat 44 has a plurality of blades 51′ forming the second fan 5′. The blades 31′ of the first fan 3′ face the blades 51′ of the second fan 5′ and the second end wall 12.

When the electric motor 2′ is supplied with electricity from the power device 8 and operates for the first time, the first rotor 24′ and the shaft 21′ of the electric motor 2′ drive the first fan 3′ to rotate, generating wind power close to the second fan 5′. The second fan 5′ is driven to rotate by the wind power in the compartment 14 of the housing 1. Furthermore, the second fan 5′ drives the second rotor 42 of the generator 4 to rotate. The magnetic lines of the first magnets 6 and the second magnets 7 create repulsive and attractive forces to provide inertia driving the second rotor seat 44 to rotate, making the generator 4 continuously generate and supply electricity to the power device 8 and the electric motor 2′, thereby keeping the electric motor 2′ running to generate the wind power while the first fan 3′ continuously using the wind power to drive the second fan 5′ and the generator 4 to generate electricity. Thus, the power device 8 can continuously and stably output electricity to the external electrical appliance 9.

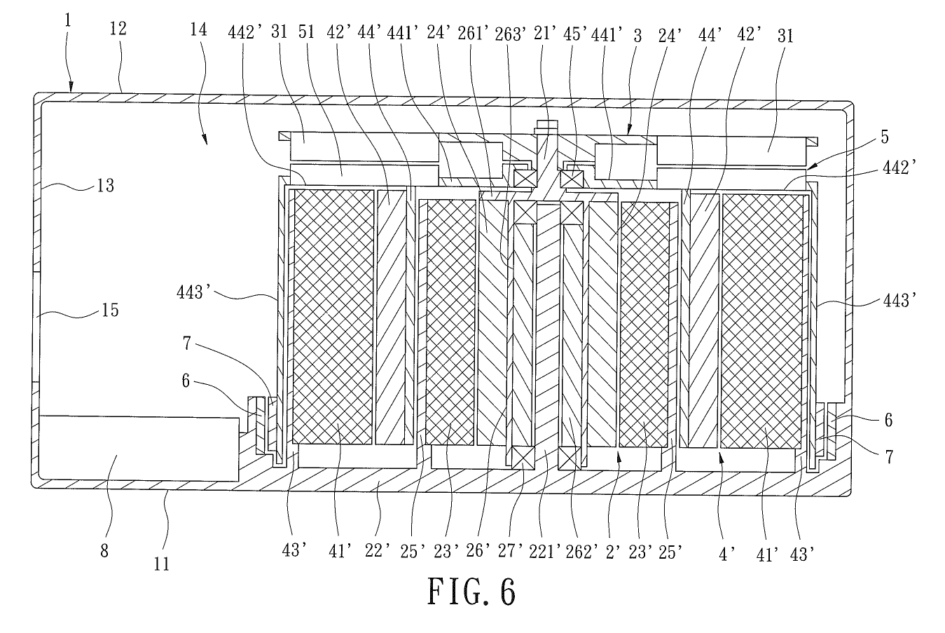

FIG. 6 show a third example of the power supply. The first stator 23′ and the first rotor 24′ of the electric motor 2′ of third example are the same of those of the second example. The third example is different from the first example by that the second stator 41′ of the generator 4′ is located around and spaced from the second rotor 42′. A second stator seat 43′ extends upwards from the fixed seat 22′. The second stator 41′ is fixed to an inner periphery of the second stator seat 43′. A second rotor seat 44′ is fixed to an inner periphery of the second rotor 42′. The second rotor seat 44′ includes an end 441′ rotatably connected to the shaft 21′ by a bearing 45′. A cylindrical portion 443′ extends outwards from the end 441′ and the ventilation holes 442′ of the second rotor seat 44′ and surrounds the second stator seat 43′. The second magnets 7 are annularly fixed around the cylindrical portion 443′ of the second rotor seat 44′.

When the electric motor 2′ is supplied with electricity from the power device 8 and operates for the first time, the first rotor 24′ and the shaft 21′ of the electric motor 2′ drive the first fan 3′ to rotate, generating wind power close to the second fan 5′. The second fan 5′ is driven to rotate by the wind power in the compartment 14 of the housing 1. Furthermore, the second fan 5′ drives the second rotor 42′ of the generator 4′ to rotate. The magnetic lines of the first magnets 6 and the second magnets 7 create repulsive and attractive forces to provide inertia driving the second rotor seat 44′ to rotate, making the generator 4′ continuously generate and supply electricity to the power device 8 and the electric motor 2′, thereby keeping the electric motor 2′ running to generate the wind power while the first fan 3′ continuously using the wind power to drive the second fan 5′ and the generator 4′ to generate electricity. Thus, the power device 8 can continuously and stably output electricity to the external electrical appliance 9.

Although specific embodiments have been illustrated and described, numerous modifications and variations are still possible without departing from the scope of the invention. The scope of the invention is limited by the accompanying claims.

1. A power supply comprising:
a housing including a first end wall, a second end wall, and a peripheral wall interconnected between the first and second end walls, defining a compartment therebetween, with the housing further including at least one vent intercommunicated with the compartment;
an electric motor including a fixed seat fixed to the first end wall and located in the compartment, with the electric motor further including a shaft having an end extending perpendicularly to and rotatably mounted to the fixed seat, with the electric motor further including a first stator having an end fixed on the fixed seat and a first rotor fixed to the shaft, with the first stator and the first rotor concentrically mounted around the shaft, and with another end of the shaft extending beyond the first stator;
a first fan fixed to the other end of the shaft;
a generator concentrically mounted around the electric motor, with the generator including a second stator and a second rotor concentrically disposed in relation to the second stator, with the second stator having an end fixed to the fixed seat, with a second rotor seat fixed to the second rotor, and with the second rotor seat including an end rotatably mounted to the other end of the shaft;
a second fan fixed to the end of the second rotor, with the second fan facing the first fan, with the first and second fans being coaxial, opposite to each other, and adjacent to each other;
at least one first magnet fixed in the compartment and located outside of the generator;
a plurality of second magnets annularly fixed around the second rotor seat, with the at least one magnet surrounding the plurality of second magnets; and
a power device mounted to the housing, with the power device electrically connected to the generator and the electric motor, and with the power device adapted to supply electricity to an outside,
wherein when the electric motor is supplied with electricity from the power device and operates, the first rotor and the shaft of the electric motor drive the first fan to rotate, generating wind power close to the second fan, wherein the second fan is driven to rotate by the wind power in the compartment of the housing, with the second fan driving the second rotor and the second rotor seat of the generator to rotate, with magnetic lines of the at least one first magnet and the plurality of second magnets creating repulsive and attractive forces to provide inertia driving the second rotor seat to rotate, making the generator continuously generate and supply electricity to the power device and the electric motor, thereby keeping the electric motor running, and wherein the power device is adapted to output electricity to an external electrical appliance.

2. The power supply as claimed in claim 1, with the first rotor of the electric motor located around and spaced from the first stator, with a first stator seat extending upwards from an intermediate portion of the fixed seat and having an axial hole, with the shaft rotatably extending through the axial hole, with the first stator fixed around the first stator seat, with a first rotor seat fixed around the first rotor, and with the first rotor seat including an end fixed to the shaft, and with the second rotor seat fixed around the second rotor.

3. The power supply as claimed in claim 1, with a side of the first fan located adjacent to the second end wall, and with the second fan located adjacent to another side of the first fan.

4. The power supply as claimed in claim 1, with the end of the second rotor seat of the generator including a plurality of ventilation holes, and with the second fan including a plurality of blades formed on the end of the second rotor seat.

5. The power supply as claimed in claim 1, with each of the plurality of second magnets including two ends having opposite polarities, with two adjacent ends respectively of two adjacent second magnets having opposite polarities, with the at least one first magnet extending along an axis parallel to and spaced from a tangent to one of the plurality of second magnets and having two ends with opposite polarities.

6. The power supply as claimed in claim 1, with the plurality of second magnets arranged in a circumferential direction and spaced from each other, with each of the plurality of second magnets including inner and outer sides having opposite polarities, with the polarities of the outer sides of the plurality of second magnets being identical, with the at least one first magnet extending along an axis parallel to and spaced from a tangent to one of the plurality of second magnets and including a first side facing one of the plurality of the second magnets, and with the first side of the at least one first magnet having a polarity identical to the polarity of the outer side of the one of the plurality of second magnets.

7. The power supply as claimed in claim 1, with the first stator of the electric motor located around and spaced from the first rotor, with an axle extending upwards from an intermediate portion of the fixed seat, with a first rotor seat fixed to an inner periphery of the first rotor, with the first rotor seat including an end fixed to the shaft, with the first rotor seat further including an axial hole extending downwards and rotatably receiving the axle, with a first stator seat extending upwards from the fixed seat, and with the first stator fixed to an inner periphery of the first stator seat.

8. The power supply as claimed in claim 7, with the second rotor of the generator located around and spaced from the second stator, with the second stator fixed around the first stator seat, with the second rotor seat fixed around the second rotor, with the end of the second rotor seat including a first side located adjacent to the second end wall and surrounding the first fan, with the end of the second rotor seat including a plurality of ventilation holes, and with the end of the second rotor seat further including a second side having a plurality of blades forming the second fan.

9. The power supply as claimed in claim 7, with the second stator of the generator located around and spaced from the second rotor, with a second stator seat extending upwards from the fixed seat, with the second stator fixed to an inner periphery of the second stator seat, with the second rotor seat fixed to an inner periphery of the second rotor, a cylindrical portion extending outwards from the end of the second rotor seat and surrounding the second stator seat, with the plurality of second magnets annularly fixed around the cylindrical portion of the second rotor seat, and with the first fan having a side adjacent to the second end wall, and with the second fan located adjacent to another side of the first fan.

10. The power supply as claimed in claim 1, with the power device including a charging controller, a rechargeable battery, and a voltage boost circuit, with the charging controller electrically connected to the generator and the rechargeable battery, with the rechargeable battery electrically connected to the electric motor and the voltage boost circuit, and with the voltage boost circuit adapted to be electrically connected to the external electrical appliance.
